(19) United States
(12) Patent Application Publication
(10) Pub. No.: US 2025/0079854 A1
(43) Pub. Date: Mar. 6, 2025

(54) CHARGING METHOD AND SYSTEM FOR SERIES-CONNECTED RECHARGEABLE BATTERY CELLS

(71) Applicant: TAIWAN TRUEWIN TECHNOLOGY CO., LTD., Hsinchu City (TW)

(72) Inventors: Tsung-Tien CHENG, Hsinchu City (TW); Jui-Min TSAI, Hsinchu City (TW)

(21) Appl. No.: 18/456,578

(22) Filed: Aug. 28, 2023

(51) Int. Cl. H02J 7/00; H01M 10/46; H01M 10/48

(52) U.S. Cl. CPC H02J 7/0014; H01M 10/46; H01M 10/482; H02J 7/00304; H02J 7/0047; H02J 7/007182

(57) ABSTRACT

The present invention relates to a charging method and system for series-connected rechargeable battery cells. Specifically, it employs a first set and a second set of relays with a specific electrical coupling. Firstly, turning off all second relays, and turning on all first relays to charge the battery cells. When a specific battery reaches a preset charging condition, a corresponding first relay is deactivated to halt charging that particular battery. At the same time, a corresponding second relay is activated to continue charging the remaining battery cells.

### BACKGROUND

### Technical Field

The present invention relates to a charging method and system for series-connected rechargeable battery cells, particularly a method and system that can achieve balanced charging effects for each series-connected battery cell.

### Description of Related Art

### FIG. 1 Shows a Prior Art

FIG. 1 shows a charging method according to Taiwan Patent No. TWI755116B, which assumes charging lithium battery cells connected in series with a charging voltage of 544V/15A. FIG. 1 prior art illustrates that the first step is to initiate charging, and the second step is to determine whether the total voltage is higher than the target voltage of 544V. If yes, then the charging process terminates. If not, charging continues. This conventional technique achieves the desired total voltage after charging the battery cells, but individual cell voltages can vary. Calculating an average voltage of 3400 mV per cell by using 544V/160, it is assumed that if one cell has a voltage of 3200 mV, there must be another cell with a voltage of 3600 mV to make the average equal to 3400 mV. This discrepancy is due to inherent differences in each battery cell, including material variations and process errors, resulting in uneven charging differences even under the same charging conditions.

### FIG. 2 Shows Battery Cells Charged According to FIG. 1

FIG. 2 illustrates that after using this conventional charging technique of FIG. 1, there will be different charging states among different battery cells. For instance, battery cell 31 has a lower charge level than the average charge line L1, battery cell 32 has a higher charge level than the average charge line L1, and battery cell 33 has a charge level approximately equal to the average charge line L1. Due to the cliff-like drop at the end of the discharge curve of lithium battery cells, the differences in charge levels among these battery cells lead to a decrease in overall power supply efficiency.

### SUMMARY OF THE INVENTION

This invention provides a charging method and system for series connected rechargeable battery cells. Each charging battery cell socket is electrically coupled to a pre-configured circuit comprising a first relay and a second relay. The second relay is initially turned off while the first relay is activated. When a specific rechargeable battery cell reaches a predetermined state of charge, the corresponding first relay is deactivated, causing the charging process for that specific rechargeable battery to cease. Simultaneously, the corresponding second relay is activated to continue charging other rechargeable battery cells.

### BRIEF DESCRIPTION OF THE DRAWINGS

FIG. 1 shows a prior art.

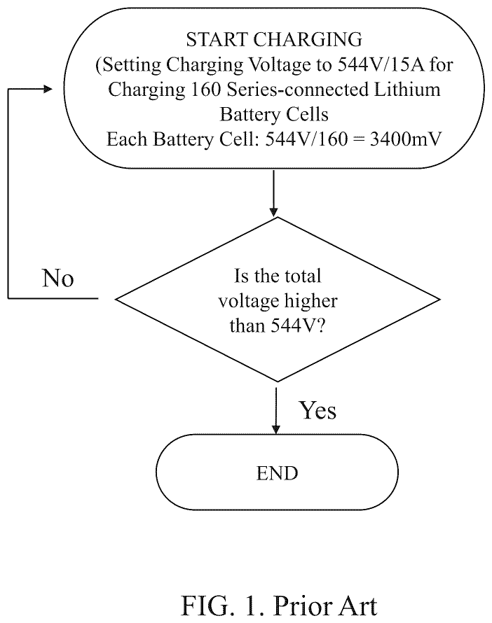

FIG. 2 shows battery cells charged according to FIG. 1

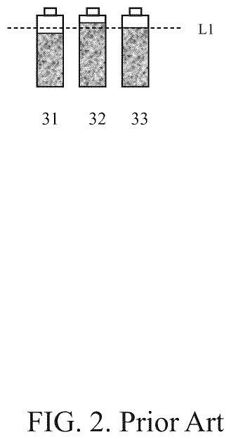

FIG. 3 shows a charging system according to the present invention.

FIG. 4 shows a charging method according to the present invention.

### DETAILED DESCRIPTION OF THE INVENTION

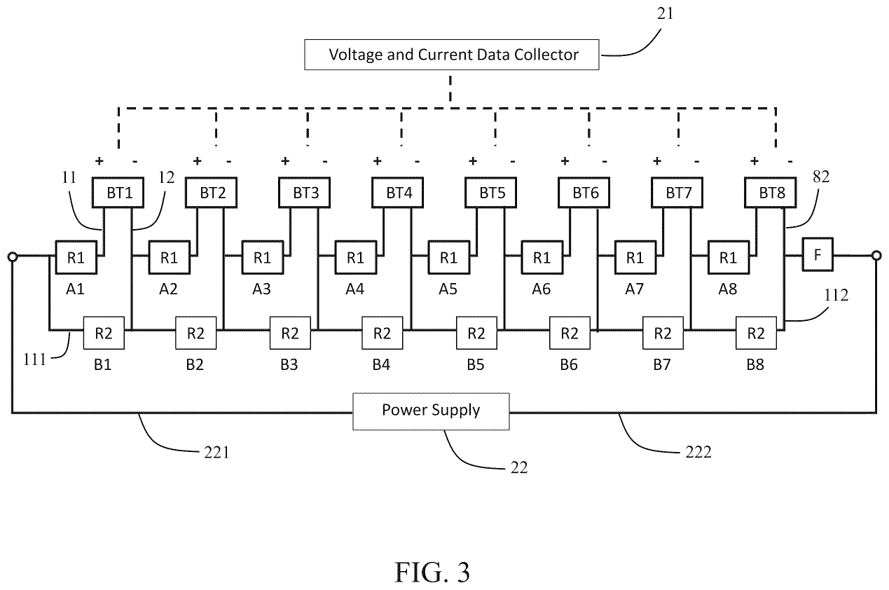

FIG. 3 shows a charging system according to the present invention.

FIG. 3 shows a charging system for series-connected rechargeable battery cells using eight battery cell sockets as an example. Each battery cell socket (BTx) can accommodate one rechargeable battery cell for charging. FIG. 3 shows the system comprises:

eight battery cell sockets (BT1˜BT8), a first battery cell socket (BT1) has a first electrode (11) electrically coupled to a first terminal of a corresponding first relay (R1) (A1). The first battery cell socket (BT1) has a second electrode (12) electrically coupled to a corresponding first relay (R1)(A2) of a next battery cell socket (BT2), and the second electrode 12 is also electrically coupled to a corresponding second relay R2 (B1). The remaining seven battery cell sockets (BT2˜BT8) have a similar structure to the first battery cell socket (BT1) mentioned above.

All the eight second relays R2 (B1˜B8) are arranged in series-connected with each other. For the series-connected second relays R2 (B1˜B8), a first electrode 111 is electrically coupled to a second terminal of the first relay R1 (A1), and a second electrode 112 is electrically coupled to a second electrode 82 of the eighth battery cell socket BT8.

A power supply 22, with its first electrode 221 electrically coupled to a second end of the first relay R1 (A1), and a second electrode 222 of the power supply 22 electrically coupled to the second electrode 82 of the eighth battery cell socket BT8.

A voltage current collector 21, electrically coupled to each and all the battery cell sockets (BT1˜BT8), collecting the electrical characteristics information of each and all battery cells during charging.

A fuse F is configured between the second terminal 82 of the eighth battery cell socket BT8 and the second electrode 222 of the power supply unit 22, the fuse F is designed to disconnect the power supply in the event of overcurrent, to protect the charging system.

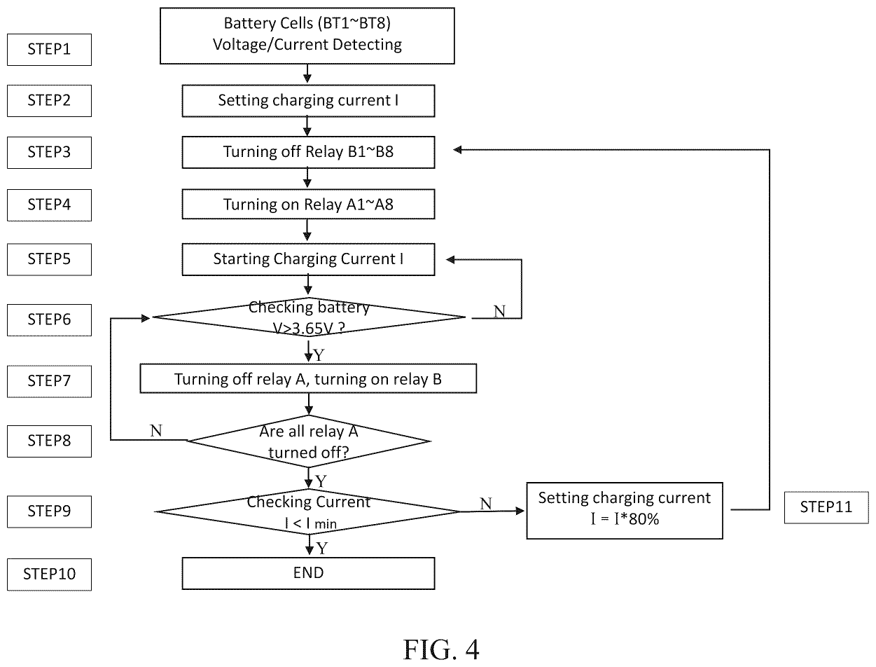

### FIG. 4 Shows a Charging Method According to the Present Invention.

FIG. 4 illustrates a charging method for rechargeable battery cells with multiple rechargeable battery cells connected in series, wherein each rechargeable battery cell has a first electrode and a second electrode. The first electrode is electrically coupled to a corresponding first relay R1, and the second electrode is electrically coupled to a corresponding second relay R2.

Using eight lithium iron phosphate battery cells with a rated voltage of 3.2V and a full charge voltage of 3.65V as an example, the charging steps according to the present invention include:
(1) Battery cells (BT1˜BT8) voltage/current detecting;
(2) Setting charging current, I;
(3) Turning off all second relays R2 (B1˜B8);
(4) Turning on all first relays R1 (A1˜A8);
(5) Starting charging current, I;
(6) Checking if the voltage of each battery cell has reached the pre-set voltage value (e.g. 3.65V for lithium iron phosphate battery cell). If yes,
(7) Turning off a corresponding first relay R1 and turning on a corresponding second relay R2;
(8) Are all second relays R2 turned off? If yes,
(9) Checking if current I<I min. If yes,
(10) Ending the process.

Wherein, step (6) further includes: If not, then return to step (5).

Wherein, step (8) further includes: If not, then return to step (6).

Wherein, step (9) further includes: If not, then return to step (11): Setting the charging current to reduce to a pre-set percentage value (80% is exemplified in the diagram), then return to step (3).

Wherein, the pre-set voltage value mentioned in step (6) refers to a nominal voltage of a fully charged rechargeable battery cell (3.65V for lithium iron phosphate batteries).

Wherein, the pre-set percentage value mentioned in step (11) can be between 1% and 99%, herein the FIG. 4, 80% is used as an example.

While several embodiments have been described by way of example, it will be apparent to those skilled in the art that various modifications can be made without departing from the spirit of the appended claims.

What is claimed is:

1. A charging method for series-connected rechargeable battery cells, comprises multiple rechargeable battery cells connected in series, wherein each rechargeable battery cell has a first electrode and a second electrode, the first electrode is electrically coupled to a corresponding first relay, and the second electrode is electrically coupled to a corresponding second relay; the charging steps include:
(1) Battery cells voltage/current detecting;
(2) Setting a charging current, I;
(3) Turning off all second relays;
(4) Turning on all first relays;
(5) Starting charging current, I;
(6) Checking if the voltage of each battery cell has reached a pre-set voltage value. If yes,
(7) Turning off the corresponding first relay and turning on the corresponding second relay;
(8) Are all second relays turned off? If yes,
(9) Checking if current I<I min. If yes,
(10) Ending the process.

2. The charging method as claimed in claim 1, wherein step (6) further includes: If not, then return to step (5).

3. The charging method as claimed in claim 1, wherein step (8) further includes: If not, then return to step (6).

4. The charging method as claimed in claim 1, wherein step (9) further includes: If not, going to step (11): Set the charging current to decrease to a pre-set percentage value, then return to step (3).

5. The charging method as claimed in claim 1, wherein the pre-set voltage value mentioned in step (6) refers to a nominal voltage of a fully charged rechargeable battery cell.

6. The charging method as claimed in claim 1, wherein the pre-set percentage value mentioned in step (11) refers to 1˜99%.

7. The charging method as claimed in claim 6, wherein the pre-set percentage value mentioned in step (11) refers to 80%.

8. A charging system for series-connected rechargeable battery cells comprises:
multiple battery cell sockets, wherein each battery cell socket has a first electrode and a second electrode;
the first electrode is electrically coupled to a corresponding first relay's first terminal;
the second electrode is electrically coupled to a corresponding first relay of a next battery cell socket, and
the second electrode is further electrically coupled to a corresponding second relay;
wherein, all the second relays are arranged in series-connected;
wherein, the series-connected second relays has a first electrode electrically coupled to a second terminal of a corresponding first relay of the first battery cell socket, the series-connected second relays has a second electrode electrically coupled to a second electrode of the last battery cell socket;
a first electrode of a power supply is electrically coupled to the second end of the corresponding first relay of the first cell socket; and
a second electrode of the power supply is electrically coupled to the second electrode of the last battery cell sockets.

9. The charging system as claimed in claim 8, further comprises:
a voltage current collector, electrically coupled to each and all of the battery cell sockets, which collects electrical characteristic information of each and all battery cells during operation.

10. The charging system as claimed in claim 8, further comprises a fuse, configured between the second electrode of the last battery cell socket and the power supply, so that the fuse shall disconnect the power supply in the event of overcurrent, in order to protect the charging system.
